(19) United States
(12) Patent Application Publication
(10) Pub. No.: US 2011/0161156 A1
(43) Pub. Date: Jun. 30, 2011

(54) Method for Providing a Loyalty Program to a Radiofrequency Tag Bearer

(75) Inventors: Jeremie Leroyer, Paris (FR); Cyril Porteret, Paris (FR)

(73) Assignee: AIRTAG, Vanves (FR)

(21) Appl. No.: 13/060,729

(22) PCT Filed: Jul. 17, 2009
(86) PCT No.: PCT/FR09/00887

§ 371 Date: Feb. 25, 2011

(30) Foreign Application Priority Data
Aug. 26, 2008 (FR) 0804714

(51) Int. Cl. G06Q 30/00

(52) U.S. Cl. 705/14.27

(57) ABSTRACT

A method for providing a loyalty program to a radiofrequency tag bearer includes during a purchase by the bearer, identifying said tag bearer by the public identifier from the radiofrequency tag thereof; correlating between the public identifier and database entries related to a buying history of the tag bearer; and determining a possible benefit to be given to the tag bearer on the basis of the entries corresponding to the public identifier. A network for implementing such a method and to a sales outlet integrating such a network are described.

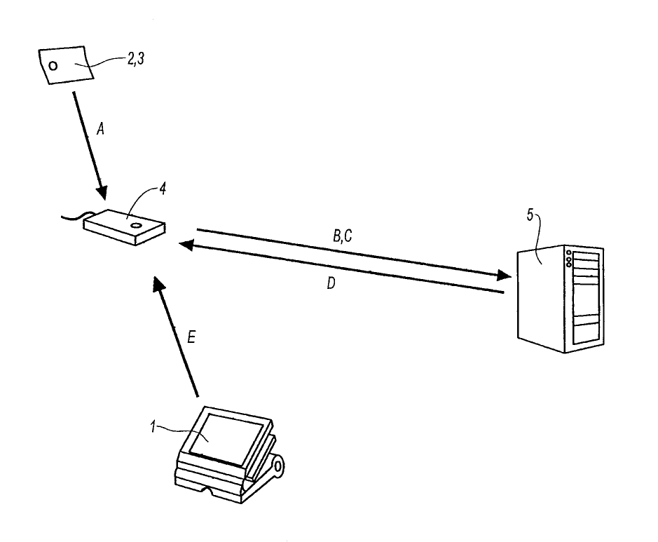

### BACKGROUND

The invention relates to a method for providing a loyalty program to a radiofrequency tag bearer, a network for the implementation of such a method and a sales outlet including such a network.

Conventionally, a retail chain may provide a loyalty program to a customer by furnishing a specific identification means, such as a loyalty card, identifying the customer in any of the sales outlets of the chain. In particular, the loyalty card contains personal information on the customer, which is mapped with a database to determine the rewards to be awarded to the customer based on loyalty.

However, these loyalty programs and the associated cards prove to be complex and expensive to set up for the retail chain. Moreover, the handling of personal information on customers is severely regulated by legislation. Furthermore, the multiplication of loyalty cards in customers' wallets is not satisfactory.

### SUMMARY OF THE INVENTION

The invention aims to solve the problems of the prior art by particularly offering a method for providing a loyalty program which is anonymous and simple to implement.

For this purpose, according to a first aspect, the invention relates to a method for providing a loyalty program to a radiofrequency tag bearer, said method comprising:

during a purchase by the bearer, identification of said bearer by means of the radiofrequency tag public ID;

mapping between said public ID and entries in a database relating to said bearer's consumption log;

determination of a potential reward to be awarded to the bearer based on the entries corresponding to the public ID.

According to a second aspect, the invention relates to a network for the implementation of such a method, said network comprising:

at least one sales system consisting of a cash register connected to a radiofrequency tag public ID scanning terminal;

a server hosting the database linking public IDs with entries relating to a consumption log;

means for determining a potential reward to be awarded by mapping between a public ID and the entries saved in said database.

According to a third aspect, the invention relates to a sales outlet comprising a plurality of cash registers, said cash registers being included in such a network.

### BRIEF DESCRIPTION OF THE DRAWINGS

Further specificities and advantages of the invention will emerge in the description hereinafter, with reference to the appended FIGURE illustrating a network for the implementation of a method for providing a loyalty program according to one embodiment of the invention.

### DETAILED DESCRIPTION OF THE PREFERRED EMBODIMENT(S)

A method for providing a loyalty program suitable for implementation by retail chains and particularly chains handling high traffic in urban areas with busy public transport links, such as fast food, snack bar, bakery, newsagent and tobacconist chains, is described hereinafter.

In particular, the chain may have, under its own ownership or under a franchise, a plurality of sales outlets each equipped with a plurality of cash registers 1 for the payment of purchases made by customers, and optionally for ordering said purchases.

As a medium for the loyalty program, the method provides for the use of an electronic medium 2 already used and carried by the customer, such as a travel card, electronic house key, office pass, subscription card. The invention thus enables the retail chain to eliminate the cost and administration of specific loyalty cards for its loyalty program. In an alternative embodiment, the electronic medium 2 may be specific for the retail chain.

The electronic medium comprises an RFID (or Radiofrequency Identification) type radiofrequency tag 3 comprising a transponder in the form of an electronic chip and a communication antenna. Indeed, this type of tag enables contactless communication between the content of the electronic chip and a suitable scanning terminal 4, said communication enabling the scanning of the information contained in the chip and/or writing of information in said chip. In particular, the contactless communication is carried out using near field communication (NFC) technology as defined by the RFID 13.56 standard.

As standard, in addition to the specific information on the use of the radiofrequency tag 3 (referred to as private information), all radiofrequency tags 3 comprise a public ID in alphanumeric string form. In particular, this public ID is unique for a tag 3 and does not contain any information other than the ID number of said tag.

Scanning the public ID thus makes it possible to identify a radiofrequency tag 3. The method according to the invention uses this identification to provide a loyalty program for the bearer of the radiofrequency tag 3, regardless of the identity of said bearer, so as to benefit from anonymous customer identification.

For this purpose, the method comprises, during a purchase by the bearer of a radiofrequency tag 3, an identification of said bearer by means of the public ID of the bearer's radiofrequency tag 3. In this way, the implementation of the method is anonymous in relation to the bearer's identity, in that, in particular, no personal information is used by the loyalty program.

The public ID is then mapped with entries in a database relating to said bearer's consumption log and any reward to be awarded to the bearer is determined on the basis of the entries corresponding to the public ID. In this way, only the public ID of the radiofrequency tag 3 is saved in the database.

When the bearer enters a sales outlet in the chain, he/she is identified by means of the public ID of the radiofrequency tag 3 and a reward may be awarded on the basis of the bearer's consumption log. In particular, if a customer has a plurality of radiofrequency tags 3, he/she may be identified with that of his/her choice.

According to one embodiment, the reward awarded to the bearer is processed in the current purchase. In this way, the bearer can benefit from immediate rewards without having to sign up to a loyalty program. In particular, the reward may consist of a discount deducted directly from the current purchase.

The method then envisages that the entries relating to the current purchase are saved in the database in order to complete the consumption log corresponding to the public ID. In this way, for a subsequent purchase with the same public ID, the reward awarded will depend on the previous purchase. Furthermore, if a reward is awarded, the consumption log is updated to account for the reward.

For the first identification of the bearer with a radiofrequency tag 3, the method envisages that the entries in the database are created in real time. Furthermore, to meet data management requirements, the bearer can have the option of cancelling the database entries corresponding to his/her public ID. For this purpose, in the sales outlet, the radiofrequency tag 3 may be arranged to scan on the terminal 4 for an extended time, for example 5 seconds, until an indicator lights up on said terminal, and the cancellation is then confirmed by a further identification.

The database entries can be selected from the purchase amount, items purchased, sales outlet ID, date and time of purchase. Furthermore, the determination of a potential reward to be awarded is configurable on the basis of a threshold of at least one database entry.

With reference to the FIGURE, a network for the implementation of a method for providing a loyalty program is described, said network comprising at least one sales system consisting of a cash register 1 connected to a radiofrequency tag 3 public ID scanning terminal 4.

In particular, the scanning terminal 4 may be of the interactive point-of-sale (POS) advertising type and be in any form compatible with the design of the sales outlet, particularly in the form of a console or wall-mounted display, and comprises a zone where the bearer is invited to pass his/her radiofrequency tag to carry out identification. Furthermore, the management organisations of the radiofrequency tags 3 used can certify the terminal 4 as not being likely to damage said tags.

The network also includes a remote server 5 hosting the database linking the public IDs with entries relating to a consumption log. Moreover, the network comprises means for determining a potential reward to be awarded by mapping between a public ID and the entries saved in said database.

In particular, the sales system is connected to the server 5 via an IP connection. Moreover, the terminal 4 and/or the cash register 1 comprise software for real-time entry processing and for determining any rewards.

In this way, after scanning A a public ID via the terminal 4, said public ID is sent B to the server 5. The scanning terminal 4 then exchanges with the server 5 to process the reward awarded during the purchase. In particular, the terminal 4 queries C the server 5 to find out the bearer's consumption log and, once the total amount exceeds a configurable threshold, a reward defined by the chain, for example a discount or a free product, is sent D to the terminal 4 so that the bearer can benefit immediately. After the purchase has been registered and settled, the entries relating to said purchase are sent E by the cash register 1 to the terminal 4 and saved in the database.

In particular, the terminal 4 may comprise signalling means, for example light or audio signalling, for handling the reward awarded, said means being activated by the transmission D of the reward awarding information from the server 5 to the terminal 4. Indeed, during signalling, the cashier working on the cash register 1 can then activate the reward to be awarded, particularly by pressing the key on said cash register corresponding to said reward.

According to one embodiment, the scanning terminal is connected to a printer port on the cash register 1, said terminal comprising means, particularly in the form of a software application, for converting the data from said post into database entries. In an alternative embodiment, the scanning terminal 4 may be connected to a further port on the cash register 1, the conversion means then being suitable for the data from said port.

According to a further aspect, the invention relates to a sales outlet comprising a plurality of cash registers 1, said cash registers being included in sales systems in a network as described above, particularly such that the sales systems are connected to the same server 5. Furthermore, the same server 5 may be used for a plurality of sales outlets of the retail chain providing the loyalty program.

1-12. (canceled)

13. Method for providing a loyalty program to a radiofrequency tag bearer, said method comprising:
during a purchase by the bearer, identification of said bearer by means of a radiofrequency tag public ID;
mapping between said public ID and entries in a database relating to a consumption log for said bearer and;
determining a potential reward to be awarded to the bearer based on the entries corresponding to the public ID.

14. Method according to claim 13, further comprising processing a reward awarded to the bearer in a current purchase.

15. Method according to claim 14, further comprising saving entries relating to the current purchase in the database.

16. Method according to any of claim 15, further comprising creating the entries in the database in real time at a time of a first identification of the bearer.

17. Method according to claim 13, further comprising selecting the database entries from a purchase amount, items purchased, sales outlet ID, date and time of purchase.

18. Method according to claim 13, wherein the step of determining a potential reward to be awarded comprises configuring the reward on a basis of a threshold of at least one database entry.

19. Network for the implementation of a method for providing a loyalty program, said network comprising:
at least one sales system consisting of a cash register connected to a radiofrequency tag public ID scanning terminal;
a server hosting a database linking public IDs with entries relating to a consumption log; and
means for determining a potential reward to be awarded by mapping between a public ID and the entries saved in said database.

20. Network according to claim 19, wherein the scanning terminal exchanges with the server to process the reward awarded during the purchase.

21. Network according to claim 20, wherein the terminal comprises signalling means for processing the reward awarded.

22. Network according to claim 19, wherein the scanning terminal is connected to a printer port on the cash register, and said scanning terminal comprising means for converting data from a post into database entries.

23. Network according to claim 19, wherein each said sales system is connected to the server via an IP connection.

24. Sales outlet comprising a plurality of cash registers (1), said cash registers being included in sales systems in a network according to claim 19.
